(19) United States
(12) Patent Application Publication
(10) Pub. No.: US 2010/0271733 A1
(43) Pub. Date: Oct. 28, 2010

(54) HARD DISK DRIVE

(75) Inventor: Dae Il Kim, Hwasung-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/766,108

(22) Filed: Apr. 23, 2010

(30) Foreign Application Priority Data
Apr. 24, 2009 (KR) 10-2009-0036032

(51) Int. Cl. G11B 5/60

(52) U.S. Cl. 360/236.6; G9B/5.229

(57) ABSTRACT

A hard disk drive includes an end tap which extends from an end part of a suspension and supports a slider; a ramp which includes a parking guide rail including a parking guide wall on which the end tap is contact-guided and parked when a disk stops rotating; and a ramp rotating unit which is connected to the ramp and rotates the ramp based on parking states of the end tap.

### CROSS-REFERENCE TO RELATED PATENT APPLICATIONS

This application claims priority from Korean Patent Application No. 10-2009-0036032, filed on Apr. 24, 2009 in the Korean Intellectual Property Office, the disclosure of which is incorporated herein by reference.

### SUMMARY

The inventive concept relates to an auxiliary memory unit of a computer system, and more particularly, to a hard disk drive which can properly adjust a position of a ramp according to parking states, so that a parking guide surface of a ramp for contacting and guiding an end tap can be suitably selected depending on conditions. One or more exemplary embodiments provide a hard disk drive capable of making a slider have a stable flying height before coming into contact with an outer disk crash stop (ODCS) by effectively reducing vibration of the slider when the slider is parked, particularly, at emergency parking.

According to an aspect of an exemplary embodiment, there is provided a hard disk drive including: an end tap which extends from an end part of a suspension and supports a slider; a ramp which comprises a parking guide rail including a parking guide wall on which the end tap is contact-guided and parked when a disk stops rotating; and a ramp rotating unit which is connected to the ramp and rotates the ramp based on parking states of the end tap.

The parking guide wall may include a normal parking guide section on which the end tap is contact-guided when the end tap is parked during normal parking; and an emergency parking guide section adjacent to the normal parking guide section on which the end tap is contact-guided when the end tap is parked during emergency parking, wherein the ramp rotating unit rotates the ramp so that the end tap is contact-guided and parked on the emergency parking guide section when the end tap is parked during the emergency parking.

The ramp rotating unit may include a rotation shaft coupled to a side of the ramp and forming a rotation axis of the ramp; and a rotational force transmitter connected to the ramp and transmitting rotational force to rotate the ramp with respect to the rotation shaft.

The rotational force transmitter may include a shape memory device in contact with the ramp which rotates the ramp with respect to the rotation shaft by pressing the ramp due to a change in shape of the shape memory device; and a power supply which supplies electric current to the shape memory device based on the parking states of the end tap, thus changing the shape of the shape memory device.

The shape memory device may include a shape memory polymer which recovers an original state when the electric current is cut off from the power supply.

The ramp may be rotatable by the ramp rotating unit through an angle of 5 degrees to 15 degrees.

The parking guide rail may include a front end having a first section which is perpendicular to a length of the parking guide rail and a second section which is inclined with respect to the length of the parking guide rail.

The normal parking guide section may include a surface which is more planar than a surface of the emergency parking guide section.

The emergency parking guide section may be higher than the normal parking guide section.

A surface roughness of the emergency parking guide section may be different from a surface roughness of the normal parking guide section.

### BRIEF DESCRIPTION OF THE DRAWINGS

The above and/or other aspects will be more clearly understood from the following detailed description of exemplary embodiments taken in conjunction with the accompanying drawings in which:

FIG. 1 is a partial exploded perspective view of a hard disk drive according to an exemplary embodiment;

FIG. 2 is a plan view of a base area in FIG. 1;

FIG. 3 is an enlarged perspective view of a ramp area in FIG. 1;

FIG. 4 schematically shows a configuration connected to a front end part of an actuator arm shown in FIG. 3;

FIG. 5 is an enlarged perspective view of a ramp;

FIG. 6A shows a plan view of a ramp when an end tap is parked normally;

FIG. 6B shows a plan view of a ramp when an end tap is positioned during emergency parking;

FIG. 7A shows an end tap being guided to a normal parking guide section of a parking guide wall when the end tap is parked normally;

FIG. 7B shows an end tap being guided to an emergency parking guide section of a parking guide wall during emergency parking;

FIG. 8 is a graph showing a velocity over time of an end tap that is parked in the emergency parking guide section according to an exemplary embodiment and a velocity over time of an end tap that is parked in a ramp during emergency parking according to a comparative example;

FIGS. 9A and 9B schematically show a parking guide wall on a ramp of a hard disk drive according to another exemplary embodiment; and

FIGS. 10A and 10B schematically show a parking guide wall on a ramp of a hard disk drive according to still another exemplary embodiment.

### DETAILED DESCRIPTION OF EXEMPLARY EMBODIMENTS

A hard disk drive (HDD), which uses a reading/writing head to record data on a disk or read data from the disk, has been widely used as an auxiliary memory unit of a computer system or the like since it can access a lot of data at high speeds.

The reading/writing head is mounted to a slider, and the slider is supported by a suspension coupled to a front end of an actuator arm. A small hard disk drive for a disk which has a diameter of 2.5 inch or less includes a ramp on a circumference of the disk, and employs a ramp parking system to park the reading/writing head on the ramp. At an end part of the suspension is provided an end tap that is substantially parked on the ramp.

With this configuration, the slider keeps floating at a predetermined space from the disk while the hard disk drive operates, and the reading/writing head mounted to the slider reads data recorded on the disk or writes new data on the disk.

On the other hand, if the hard disk drive is turned off, the reading/writing head is parked on the ramp and thus prevented from moving toward the stopped disk. The slider and the disk may be protected from damage by parking the slider on the ramp for a moment not only when the hard disk drive is turned off but also when the hard disk drive is impacted during operation.

However, when the slider is parked, particularly, during emergency parking performed in the case that the hard disk drive is suddenly turned off or impacted by external shocks, if the slider has an unstable flying height and vibrates until the slider comes into contact with an outer disk crash stop (ODCS), degram (a phenomenon that a gram load applied to the suspension is lowered by plastic deformation of the suspension) can occur in the suspension, thereby causing problems that the performance and shock characteristic of the reading/writing head may be lowered and flying sensibility of the reading/writing head to the disk may be deteriorated.

Hereinafter, exemplary embodiments will be described with reference to the attached drawings. Like reference numerals in the drawings denote like elements.

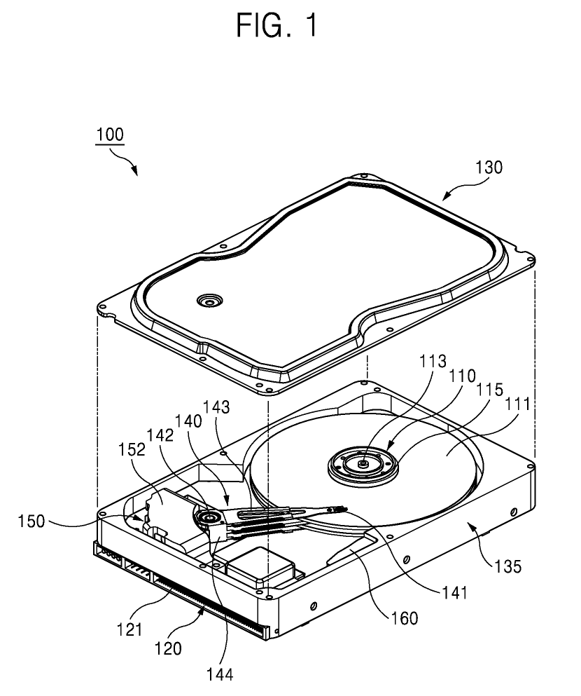

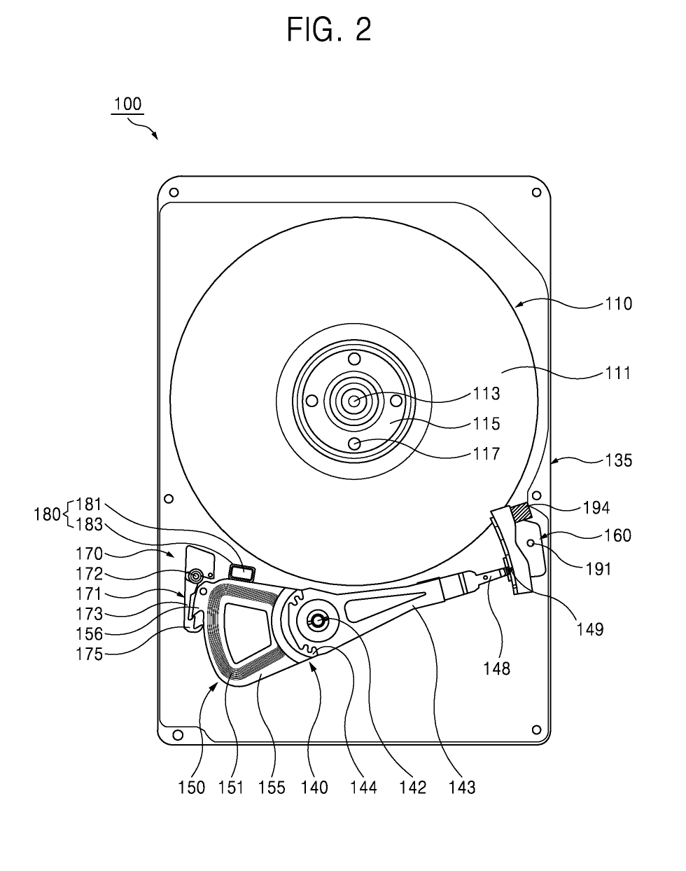

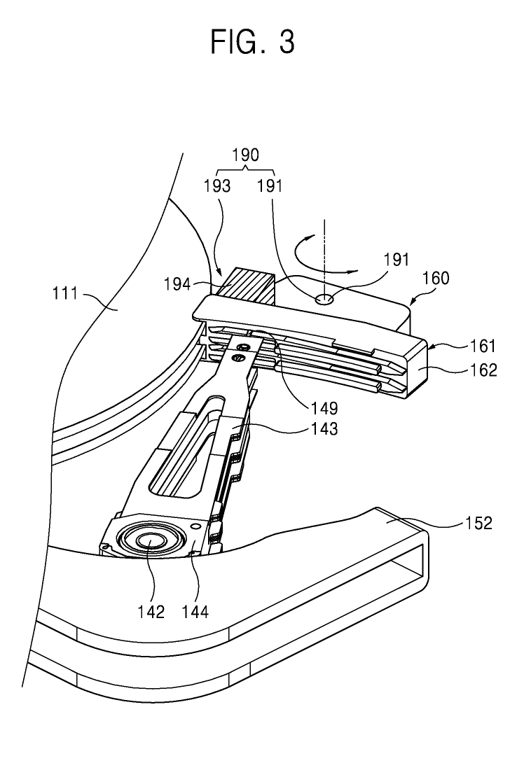

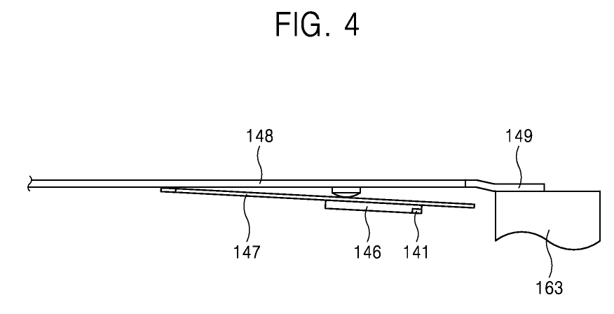

FIG. 1 is a partial exploded perspective view of a hard disk drive according to an exemplary embodiment, FIG. 2 is a plan view of a base area in FIG. 1, FIG. 3 is an enlarged perspective view of a ramp area in FIG. 1, and FIG. 4 schematically shows a configuration connected to a front end part of an actuator arm shown in FIG. 3.

Referring to FIGS. 1, 2 and 3, a hard disk drive 100 according to an exemplary embodiment includes a disk pack 110 having a disk 111; a printed circuit board assembly (PCBA) 120; a cover 130; a base 135; a head stack assembly (HSA) 140 for moving a reading/writing head 141, which writes and reads data on the disk 111, to a predetermined position on the disk 111; a voice coil motor (VCM) 150 for rotating an actuator arm 143 of the HSA 140; a ramp 160 on which an end tap 149 extended from an end part of a suspension 148 included in the HSA 140 is contact-guided and parked during periods of no operation so as to park the reading/writing head 141; a ramp rotating unit 190 for selectively rotating the ramp 160 during emergency parking based on a parking state of the end tap 149; a latch unit 170 keeping a latched engagement with the HSA 140 during periods of no operation to prevent the reading/writing head 141 from moving toward the disk 111, and a crash stop 180 to limit movement of the actuator arm 143.

An outer disk crash stop (ODCS) and an inner disk crash stop (IDCS) are provided for limiting the movement of the actuator arm 143 in order to prevent the reading/writing head 141 from moving to a position of the disk 111 where no servo information is written, or for various other reasons. In this embodiment, the crash stop 180 is the ODCS with which a bobbin 155 comes into contact when the reading/writing head 141 is parked on the ramp 160.

The disk pack 110 includes the disk 111, a shaft 113 forming a rotation axis of the disk 111, a spindle motor hub (not shown) provided at an outside of the shaft 113 in a radial direction and supporting the disk 111, a clamp 115 coupled to an upper part of the spindle motor hub, and a clamp screw 117 pressing the claim 115 and fastening the disk 111 to the spindle motor hub.

The PCBA 120 includes a printed circuit board (PCB, not shown) having a plate shape, and a PCB connector 121 provided at one side of the PCB. The PCB is provided with a plurality of chips (not shown) for controlling the disk 111 and the reading/writing head 141 and transmits and receives a signal to and from the exterior via the PCB connector 121.

The base 135 forms a rigid frame, to which the disk pack 110, the HSA 140, the PCBA 120 and the like are assembled. Further, the base 135 is provided with the ramp 160 on which the reading/writing head 141 is parked when powered off or the like.

The cover 130 covers a top surface of the base 135 and protects the disk 111, the HSA 140 and the like.

The HSA 140 is a carrier of writing data on the disk 111 or reading the data from the disk 111, which includes the reading/writing head 141 for writing data on the disk 111 or reading the data from the disk 111; an actuator arm 143 which rotates or pivots over the disk 111 with respect to a pivot shaft 142 so that the reading/writing head 141 can access data on the disk 111; a suspension 148 coupled to an end part of the actuator arm 143; a pivot shaft holder 144 coupled to and supported by the actuator arm 143 and rotatably supporting the pivot shaft 142; and the bobbin 155 provided in the pivot shaft holder 144 at an opposite side of the actuator arm 143 and placed between a pair of magnets 151 of the VCM 150.

The reading/writing head 141 senses a magnetic field formed on the surface of the disk 111 or magnetizes the surface of the disk 111, thereby reading information from or writing information on the disk 111 being rotated. The reading/writing head 141 includes a reading head for sensing the magnetic field of the disk 111 and a writing head for magnetizing the disk 111.

In one end part of the actuator arm 143, as shown in FIGS. 3 and 4, there are provided a slider 146 mounted with the reading/writing head 141, the suspension 148 supporting the slider 146 to be elastically biased toward the surface of the disk 111. The slider 146 is supported by the suspension 148 as being attached to a flexure 147. Further, the end tap 149 is mounted to and extended from an end part of the suspension 148. The end tap 149 is parked on the ramp 160 when the disk 111 stops, and prevents the reading/writing head 141 from freely moving toward the disk 111, which will be described in more detail.

The VCM 150 is a kind of driving motor for rotating the actuator arm 143 of the HSA 140 in order to move the reading/writing head 141 to a desired position on the disk 111, which employs Fleming's left hand rule, i.e., a principle that electromagnetic force is generated when an electric current is applied to a conductive body placed in a magnetic field. The VCM 150 applies the electric current to a voice coil 151 placed between magnets, thereby rotating the bobbin 155. Accordingly, the actuator arm 143 can rotate in a predetermined direction, and thus the reading/writing head 141 mounted to the end part of the actuator arm 143 can search and access a track (not shown) while moving in the radial direction of the disk 111 being rotated, thereby writing data on the disk 111 or reading the data from the disk 111.

The latch unit 170 latches the bobbin 155 connected to a back end part of the actuator arm 143 and prevents the actuator arm 143 from rotating when receiving no power.

In this embodiment shown in FIG. 2, the latch unit 170 includes a latch lever 171 rotatably mounted to the base 135 and preventing the actuator arm 143 from rotating, and a hook part 156 provided in the bobbin 155 and latched to or released from the latch lever 171.

As shown in FIG. 2, the latch lever 171 is a part rotatably coupled to the base 135 at a position adjacent to a VCM yoke 152 of VCM 150, which includes a rotation central part 172 serves as a pivot point, a latch arm 173 rotatably coupled to the rotation central part 172, and a locking part 175 provided in a front end part of the latch arm 173 and to which the hook part 156 of the bobbin 155 is latched when the actuator arm 143 is rotated counterclockwise.

Here, the latch arm 173 rotates relative to the rotation central part 172, so that the hook part 156 of the bobbin 155 can be latched to or unlatched to the locking part 175. In other words, if a clockwise or counterclockwise rotary shock is given from the exterior to the hard disk drive 100, inertia force acts on the latch arm 173 to rotate in an opposite direction to the external force. By the inertial force, the hook part 156 of the bobbin 155 can be latched to the locking part 175 protruding from the front end part of the latch arm 173, and thus the actuator arm 143 can be prevented from freely rotating.

The crash stop 180, i.e., the ODCS in this embodiment is used for limiting an angle where the actuator arm 143 moves clockwise and for reducing a rotary shock that may occur in various conditions.

The crash stop 180 includes a housing shaft 181 fastened to the base 135, and a shock-absorbing member 183 surrounding and coupled to the housing shaft 181 and directly colliding with the bobbin 155.

The shock-absorbing member 183 may be made of nitrile butadiene rubber or the like material, and decreases an impulse generated when the bobbin 155 and the crash stop 180 collide with each other.

As described above, the end tap 149 extended from the front end part of the suspension 148 is parked on the ramp 160 when the disk 111 does not rotate, and thus prevents the reading/writing head 141 from voluntarily moving toward the disk 111.

For example, if the disk 111 stops rotating, the actuator arm 143 rotates with respect to the pivot shaft 142 so that the end tap 149 provided at the front end part of the suspension 148 can be parked on the ramp 160, and thus the bobbin 155 connected to the back end part of the actuator arm 143 can be latched to the latch unit 170 as being in contact with the crash stop 180.

However, in the case of normal parking when the end tap 149 is parked as the hard disk drive 100 is normally turned off, the vibration of the slider 146 due to elasticity of the flexure 147 is small when the slider 146 mounted with the reading/writing head 141 moves to the ramp 160, so that the vibration of the slider 146 can be stabilized before the end tap 149 is completely parked on the ramp 160, i.e., before the bobbin 155 comes into contact with the crash stop 180. On the other hand, in the case of performing emergency parking when the hard disk drive 100 is suddenly turned off or impacted an external shock, the slider 146 may not be stabilized before the bobbin 155 comes into contact with the crash stop 180 since not only does the slider 146 vibrate greatly but also the end tap 149 moves quickly along the parking guide wall 163s of the ramp 163 to be described later.

Further, if the bobbin 155 connected to the back end part of the actuator arm 143 collides with the crash stop 180 while the vibration of the slider 146 is not stabilized, the vibration of the slider 146 increases. Therefore, if this phenomenon occurs repetitively, the degram occurs in the suspension 148, so that the performance and the shock characteristics of the reading/writing head 141 can be deteriorated or the flying sensibility of the reading/writing head to the disk 111 can be lowered.

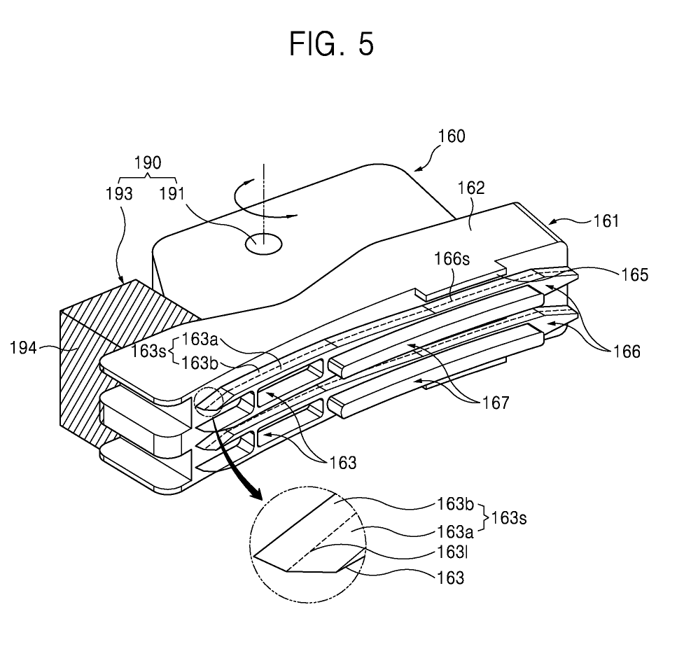

Thus, the hard disk drive according to this embodiment increases a length that the end tap 149 is contact-guided. In other words, according to this embodiment, a parking guide length is longer for emergency parking than it is for normal parking, thereby increasing a parking guide time or making the end tap 140 come into contact with a more waved part of the ramp during emergency parking than the part of the ramp contacted by the end tap 149 during normal parking. Thus, the hard disk drive in this embodiment rotates the ramp 160 selectively based on the parking state of the end tap 149 so that the vibration of the slider 146 can be stabilized before the bobbin 155 comes into contact with the crash stop 180. The latter case will be described in another exemplary embodiment, and the case, in which the parking guide time is increased by increasing the parking guide length, when the end tap 140 is parked on the ramp 160, for emergency parking more than for the normal parking, will be described with reference to FIGS. 5 to 8.

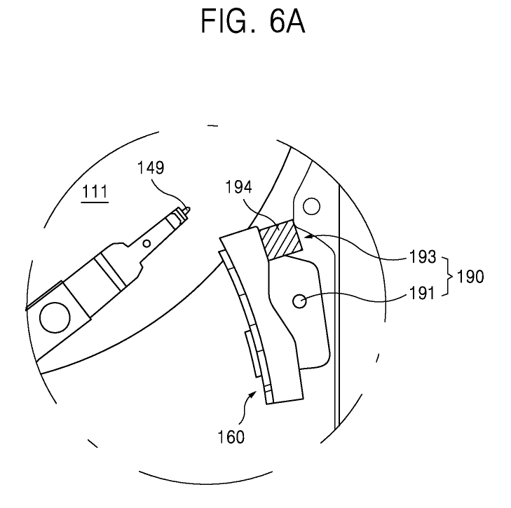

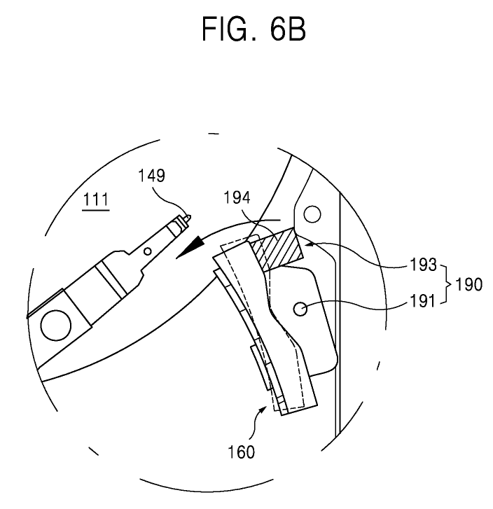

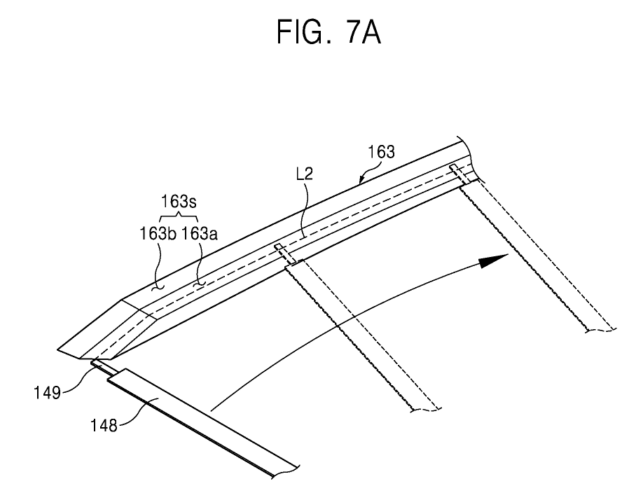

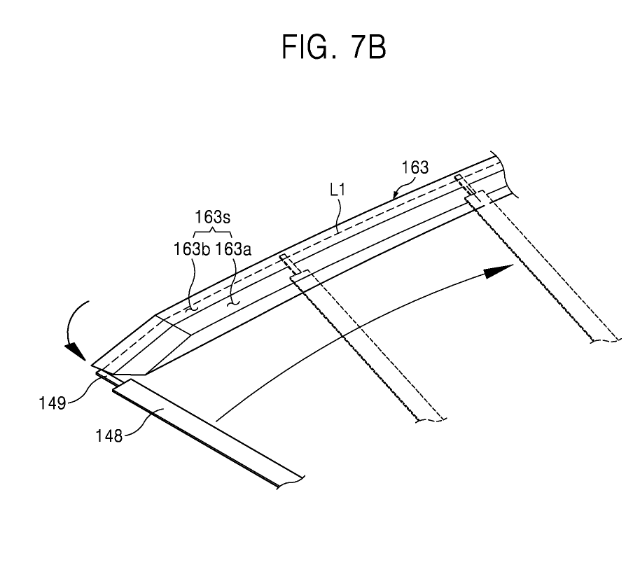

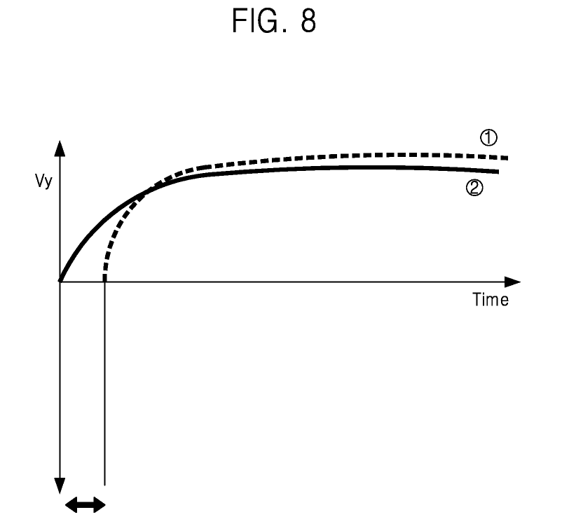

FIG. 5 is an enlarged perspective view of a ramp, FIG. 6A shows a plan view of the ramp when an end tap is parked normally, FIG. 6B shows a plan view of the ramp when the end tap positioned during emergency parking, FIG. 7A shows the end tap being guided to a normal parking guide section of a parking guide wall when the end tap is normally parked, and FIG. 7B the end tap being guided to an emergency parking guide section of the parking guide wall during emergency parking, and FIG. 8 is a graph showing a velocity over time of the end tap that parked in the emergency parking guide section according to the present exemplary embodiment and a velocity over time of the end tap being parked in a ramp during emergency parking according to a comparative example.

As shown, the hard disk drive 100 in this embodiment includes the ramp 160 rotatably coupled to one side of the base 135 and on which the end tap 149 is parked, and the ramp rotating unit 190 rotating the ramp 160 selectively based on the parking states of the end tap 149.

For reference, generally stopping the rotation of the disk 111 and parking is refers to the stopping or parking of the reading/writing head 141 (refer to FIG. 4) or the slider 146 (refer to FIG. 4) connected to the reading/writing head 141, but it also means that the end tap 140 is parked because the end tap 149 substantially contacts the ramp 160 and stops.

The ramp 160 in this embodiment can be selectively rotated by the ramp rotating unit 190 according to the parking states such as the normal parking or the emergency parking, and thus a parking guide section where the end tap 149 is contact-guided can be selected, thereby improving reliability of the parking even during emergency parking. Thus, when the slider 146 (refer to FIG. 4) is parked, particularly during emergency parking, the vibration of the slider 146 can be more effectively reduced than in a comparative example, thereby stabilizing a flying height before contacting with the ODCS.

The ramp 160 is as follows. As shown in FIG. 5, the ramp 160 in this embodiment includes a ramp main body 161, a parking guide rail 163 provided in a front surface of the ramp main body 161 and by which the end tap 149 is substantially contact-guided, an end-tap limiter 165 provided in the ramp main body 161 and adjacent to the parking guide rail 163, an assembly guide rail 166 extended from one end of the parking guide rail 163, and a flexure limiter 167 protruding from the front surface of the ramp main body 161.

First, the ramp main body 161 is coupled to the base 135 so as to rotate with respect to the rotation axis. Thus, the parking guide rail 163 provided in the ramp main body 161 can be varied in a position according to the parking states, so that the end tap 149 can be contact-guided and parked in a relatively long parking guide section during emergency parking.

The end tap limiter 165 prevents the end tap 149 from separating from the ramp 160 by an external shock when the reading/writing head 141 is parked on the ramp 160.

The assembly guide rail 166 is formed with an assembly guide wall 166s inclined at a predetermined angle. The assembly guide wall 166s forms a path for moving the end tap 149 to the parking guide wall 163s of the parking guide rail 163 when the HSA 140 is coupled to the base 135.

The flexure limiter 167 protrudes along a protruding direction of the end tap limiter 165 from the external surface of the assembly guide rail 166 or the parking guide rail 163. The flexure limiter 167 prevents the flexure 147 from separating from the ramp 160.

As shown in FIG. 5, the parking guide rail 163 is formed with the parking guide wall 163s where the end tap 149, once placed on the disk 111 when the disk 111 rotates, can be contact-guided and parked when the disk 111 stops rotating.

In this embodiment, the parking guide wall 163s includes a normal parking guide section 163a formed in an outside area of the parking guide wall 163s for contact-guiding the end tap 149 during normal parking, and an emergency parking guide section 163b formed in an inside area of the normal parking guide section 163a for contact-guiding the end tap 149 during emergency parking, thereby enabling the end tap 149 to be parked differently according to different parking states.

As shown in FIGS. 7A and 7B, in the front end of the parking guide rail 163, a front end of the normal parking guide section 163a in which the end tap 149 is inserted, is inclined with respect to a width of the ramp 160, and a front end of the emergency parking guide section 163b is substantially parallel with the width of the ramp 160 (thus substantially perpendicular to a length of the ramp 160). Thus, the length L1 of the emergency parking guide section 163b is longer than the average length L2 of the normal parking guide section 163a. That is, in the front end of the parking guide wall 163s where the end tap 149 is inserted, the front end of a center of the emergency parking guide section 163b extends further than the front end of a center of the normal parking guide section 163a.

Accordingly, if the front end of the emergency parking guide section 163b, adjacent to the disk 111, is rotated by the ramp rotating unit 190 during emergency parking, the end tap 149 can not only be more quickly inserted in the emergency parking guide section 163b but also move in the emergency parking guide section 163b which is relatively longer than the normal parking guide section 163a, so that the slider 146 can have more time to be stabilized before the bobbin 155, provided in an opposite side to the end tap 149, comes into contact with the crash stop 180, which will be described in more detail.

As described above, when the end tap 149 is parked normally on the parking guide rail 163, the vibration of the slider 146 due to the elasticity of the flexure 147 is not significant, so the vibration of the slider 146 can be stabilized while the end tap 149 moves along the shorter normal parking guide section 163a of the parking guide rail 163.

On the other hand, during emergency parking performed when the hard disk drive 100 is suddenly turned off or impacted by an external shock, the end tap 149 moves more quickly along the parking guide wall 163s of the parking guide rail 163, so that the vibration of the slider 146 might not be stabilized before the bobbin 155 comes into contact with the crash stop 180. As this phenomenon is repetitively generated, the degram may occur in the suspension 148, so that the performance and the shock characteristics of the reading/writing head 141 can be deteriorated or the flying sensibility of the reading/writing head to the disk 111 can be lowered.

To prevent such a phenomenon, the ramp rotating unit 190 in this embodiment rotates the ramp 160 to provide the emergency parking guide section 163b, which is relatively longer than the normal parking guide section 163a, within a rotating path of the end tap 149, so that the parking guide length and the parking guide time for the end tap 149 can be greater than those for the normal parking, thereby stabilizing the vibration of the slider 146 before the bobbin 155 comes into contact with the crash stop 180. As such, if the parking guide time is secured by rotating the ramp 160, it is advantageous to increase a data safety zone as much as the secured time.

Referring back to FIGS. 5 and 6, the ramp rotating unit 190 in this embodiment comprises a rotation shaft 191 coupled to the ramp main body 161 and forming a rotation axis for the ramp main body 161, and a rotational force transmitter 193 is connected to and contacts a portion of a rear surface of the ramp main body 161 and transmits rotational force so that the ramp main body 161 can rotate with respect to the rotation shaft 191.

The rotation shaft 191 passes through a rotation shaft hole penetrating the ramp main body 161 and is then fastened to the base 135. Thus, if the rotational force is transmitted from the rotational force transmitter 193 to the ramp main body 161, the ramp main body 161 can rotate with respect to the rotation shaft 191.

As shown in FIGS. 6A and 6B, the rotational force transmitter 193 includes a shape memory device 194 having a first end fastened to the base 135 and a second end coupled to the rear surface of the ramp main body 161, and a power supply (not shown) supplying electric current to the shape memory device 194 based on the parking states of the end tap 149 in order to change the shape of the shape memory device 194 and thus rotate the ramp main body 161. In this embodiment, the shape memory device 194 includes a shape memory polymer that recovers its original shape when the power supply cuts off the electric current.

With this configuration, the power supply supplies the electric current to the shape memory device 194 when the end tap 149 is parked during emergency parking, thereby expanding the shape memory device 194 as shown in FIG. 6B. Due to the expansion of the shape memory device 194, the ramp 160 rotates in an arrow direction (refer to a dotted line and a solid line) with respect to the rotation shaft 191, thereby placing the emergency parking guide section 163b within the rotating path of the end tap 149.

This state is schematically illustrated in FIG. 7B. As described above, the length L1 of the emergency parking guide section 163b is longer than the length L2 at a center portion of the normal parking guide section 163a. That is, the front end of the emergency parking guide section 163b extends further than central portion of the front end of the normal parking guide section 163a in the front end of the parking guide wall 163s in which the end tap 149 is inserted. Accordingly, in the case that the front end of the emergency parking guide section 163b relatively adjacent to the disk 111 is rotated by the ramp rotating unit 190 during emergency parking, the end tap 149 can not only be more quickly inserted in the emergency parking guide section 163b but also move in the section 163b of the emergency parking guide that is relatively longer than the normal parking guide section 163a, so that the slider 146 can be stabilized before the bobbin 155 provided in the opposite side to the end tap 149 comes into contact with the crash stop 180.

On the other hand, if the parking state of the end tap 149 is changed from the emergency parking to the normal parking, the electric current supplied to the shape memory device 194 is cut off so that the shape memory device 194 can recover its original shape as shown in FIG. 6A. At this time, the ramp main body 161 coupled to the shape memory device 194 recovers its original position, so that the normal parking guide section 163a can be placed within the rotating path of the end tap 149, which is schematically illustrated in FIG. 7A.

Thus, the ramp rotating unit 190 rotates the ramp 160 selectively based on the parking state so as to make the end tap 149 be parked in the normal parking guide section 163a if it is possible to normally park the end tap 149. On the other hand, if the end tap 149 has to be parked during emergency parking, the ramp rotating unit 190 rotates the ramp 160 in order to make the end tap 149 be parked in the emergency parking section 163b, which is longer than the normal parking guide section 163a, thereby securing the parking guide length and time for the end tap 149 to stabilize the vibration of the slider 146.

Here, a rotation angle of the ramp 160 is adjustable according to the intensity of the electric current applied from the power supply to the shape memory device 194. At this time, the rotation angle of the ramp 160 may become larger in proportion to an emergency degree of the parking state. However, since the emergency parking guide section 163b has to be placed within the rotating path of the end tap 149 during emergency parking, the rotation angle of the ramp 160 rotated by the ramp rotating unit 190 may range from about 5 degrees to about 15 degrees with respect to the position of the ramp 160 during normal parking.

In the foregoing embodiment, the rotational force transmitter 193 includes the shape memory device 194 having the first end fastened to the base 135 and the second end coupled to the rear surface of the ramp main body 161, and the power supply (not shown) supplying the electric current to the shape memory device 194 based on the parking states of the end tap 149 in order to change the shape of the shape memory device 194 and thus rotate the ramp main body 161, but is not limited thereto. Alternatively, the rotational force transmitter may include a permanent magnet coupled to the ramp main body, an electromagnet coupled to the base and interacting with the magnet, and a power supply (not shown) for supplying electric current to the electromagnet to rotate the ramp main body.

FIG. 8 is a graph showing a velocity over time of the end tap being parked in the emergency parking guide section according to an exemplary embodiment and a velocity over time of the end tap being parked in a ramp during emergency parking according to a comparative example. In FIG. 8, the graph corresponding to ‘\textcircled{1}’ shows a velocity over time of the end tap when the end tap 149 is parked in the emergency parking guide section 163b, and the graph corresponding to ‘\textcircled{2}’ shows a velocity over time of the end tap when the end tap 149 is parked in a ramp according to a comparative example.

As shown therein, when the end tap 149 is parked along the emergency parking guide section 163b in this embodiment, initial parking of the end tap 149 is more quickly achieved than in the comparative example. Further, as time goes by, the speed of the end tap 149 is reduced as compared with that in the comparative example. That is, it will be appreciated through the graph of FIG. 8 that the parking guide length and the corresponding time can be secured as the end tap 149 is contact-guided and parked along the emergency parking guide section 163b during emergency parking. Accordingly, it will be understood that the vibration of the slider 146 can be stabilized before the bobbin 155 comes into contact with the crash stop 180.

With this configuration, parking operations of the end tap 149 onto the ramp 160 during normal parking and during emergency parking of the hard disk drive 100 will be described below.

First, the operation of the end tap 149, provided at the front end part of the suspension 148, being parked on the ramp 160 during normal parking will be described. When the disk 111 stops rotating, the reading/writing head 141 of the HSA 140 moves in a direction toward the ramp 160 due to the rotation of the actuator arm 143. Then, the end tap 149 is contact-guided and parked along the normal parking guide section 163a in the parking guide wall 163s of the parking guide rail 163 of the ramp 160. During this normal parking, the vibration of the slider 146 can be stabilized as the end tap 149 slides in the normal parking guide section 163a of the parking guide rail 163.

On the other hand, the operation of the end tap 149, provided at the front end part of the suspension 148, being parked on the ramp 160 during emergency parking will be described. During emergency parking, the power supply of the ramp rotating unit 190 supplies an electric current to the shape memory device 194 and thus the shape memory device 194 is expanded like FIG. 6B. Then, the ramp main body 161 which contacts the shape memory device 194 is rotated with respect to the rotation shaft 191. That is, the position of the ramp main body 161 is changed from FIG. 6A to FIG. 6B during emergency parking.

As the ramp main body 161 rotates, the end tap 149 is contact-guided and parked along the emergency parking guide section 163b, i.e., along the relatively longer portion of the parking guide wall 163s. Here, since the emergency parking guide section 163b is relatively longer than the normal parking guide section 163a, it is possible to provide a longer parking guide length and a longer parking guide time during which the end tap 149 slides, so that the vibration of the slider 146 can be stabilized before the bobbin 155, connected to the back end part of the actuator arm 143, comes into contact with the crash stop 180, and thus the reading/writing head 141 can be reliably parked on the ramp 160.

According to this exemplary embodiment, the position of the ramp 160 is properly adjusted according to the parking states, so that the parking guide length and time for contacting and guiding the end tap 149 can be relatively longer during emergency parking as compared with during normal parking in order to stabilize the vibration of the slider 146 that may occur during emergency parking, thereby preventing the degram from occurring in the suspension 148 and preventing the flying sensibility of the reading/writing head to the disk from being deteriorated.

Also, it is possible to suppress the deformation of the slider 146 due to the vibration, so that not only can the flying sensibility of the reading/writing head to the disk be maintained but also the degram phenomenon can be prevented from occurring.

In the meantime, a hard disk drive according to another exemplary embodiment will be described with reference to the accompanying drawing. Here, the same descriptions as those of the hard disk drive according to the foregoing embodiment will be omitted as necessary.

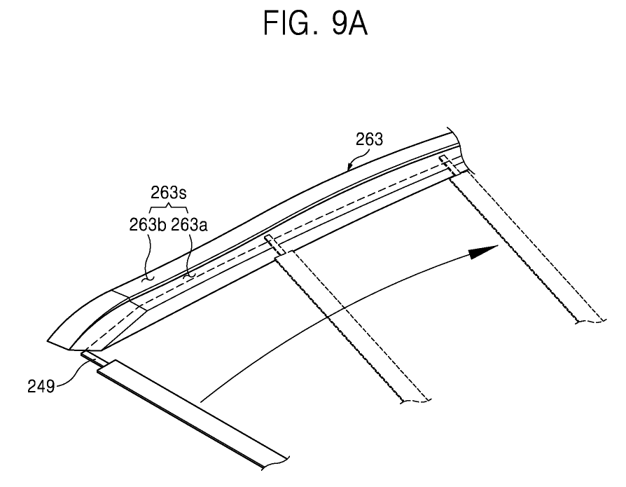

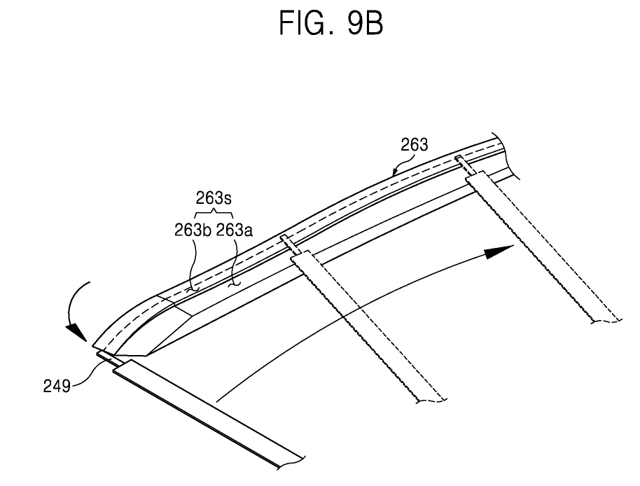

FIGS. 9A and 9B schematically show a parking guide wall on a ramp of a hard disk drive according to another exemplary embodiment of the present inventive concept.

As shown therein, a parking guide wall 263s formed in a parking guide rail 263 of the ramp according to this embodiment includes a normal parking guide section 263a where the end tap is contact-guided during normal parking, and an emergency parking guide section 263b where the end tap is contact-guided during emergency parking.

However, the emergency parking guide section 263b in this embodiment includes a waved surface different from that of the foregoing emergency parking guide section 163b (refer to FIGS. 7A and 7B). That is, the emergency parking guide section 263b is provided at a higher elevation than the normal parking guide section 263a, while the normal parking guide section 263a has a flat surface.

During emergency parking, the end tap 249 slides along the emergency parking guide section 263b having the waved surface, and it is thus possible to secure the parking guide length relatively long as compared with the flat normal parking guide section 263a and to increase the parking guide time correspondingly, thereby stabilizing the vibration of the slider before the bobbin comes into contact with the crash stop.

Additionally, a hard disk drive according to still another exemplary embodiment will be described with reference to the accompanying drawing. Here, the same descriptions as those of the hard disk drive according to the foregoing embodiment will be omitted as necessary.

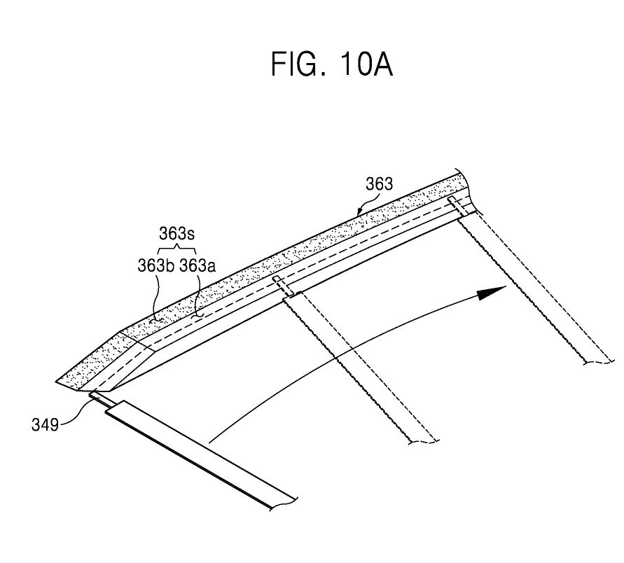

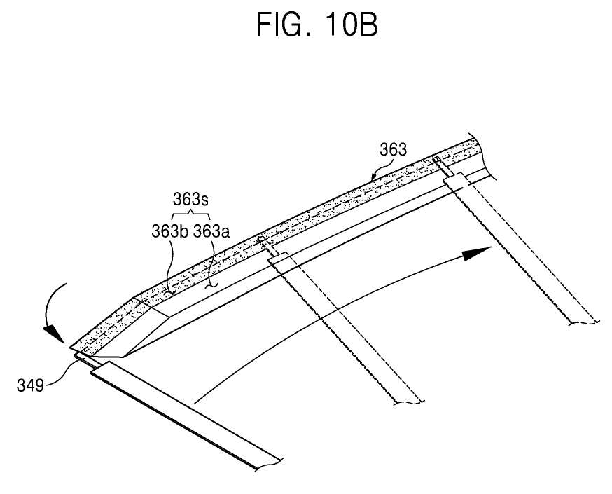

FIGS. 10A and 10B schematically show a parking guide wall on a ramp of a hard disk drive according to still another exemplary embodiment of the present inventive concept.

As shown therein, a parking guide wall 363s formed in a parking guide rail 363 of the ramp according to this embodiment includes a normal parking guide section 363a, and an emergency parking guide section 363b having a surface roughness having a relatively large damping effect, e.g., a large surface roughness as compared with that of the normal parking guide section 363a.

Thus, when an end tap 349 is contact-guided and parked in the emergency parking guide section 363b during emergency parking, i.e., when the end tap 349 slides in the emergency parking guide section 363b, the surface roughness of the emergency parking guide section 363b makes the damping effect larger than that during normal parking, thereby securing more time for stabilizing the slider than during normal parking and thus stabilizing the vibration of the slider before the bobbin comes into contact with the crash stop.

As described above, according to an exemplary embodiment, a slider can have a stable flying height before coming into contact with an outer disk crash stop (ODCS) by effectively reducing vibration of the slider as compared with a comparative example when the slider is parked, particularly, during emergency parking.

While exemplary embodiments has been particularly shown and described, it will be understood that various changes in form and details may be made therein without departing from the spirit and scope of the following claims.

What is claimed is:

1. A hard disk drive comprising:
an end tap which extends from an end part of a suspension which supports a slider;
a ramp which comprises a parking guide rail including a parking guide wall on which the end tap is contact-guided and parked when a disk stops rotating; and
a ramp rotating unit which is connected to the ramp and rotates the ramp based on parking states of the end tap.

2. The hard disk drive according to claim 1, wherein the parking guide wall comprises:
a normal parking guide section on which the end tap is contact-guided when the end tap is parked during a normal parking; and
an emergency parking guide section, adjacent to the normal parking guide section, on which the end tap is contact-guided when the end tap is parked during an emergency parking,
wherein the ramp rotating unit rotates the ramp so that the end tap is contact-guided and parked on the emergency parking guide section when the end tap is parked during the emergency parking.

3. The hard disk drive according to claim 1, wherein the ramp rotating unit comprises
a rotation shaft coupled to one side of the ramp and forming a rotation axis of the ramp; and
a rotational force transmitter connected to the ramp and transmitting rotational force to rotate the ramp with respect to the rotation shaft.

4. The hard disk drive according to claim 3, wherein the rotational force transmitter comprises:
a shape memory device which is in contact with the ramp and rotates the ramp with respect to the rotation shaft by pressing on the ramp due to a change in shape of the shape memory device; and
a power supply which supplies an electric current to the shape memory device based on the parking states of the end tap to change the shape of the shape memory device.

5. The hard disk drive according to claim 4, wherein the shape memory device comprises a shape memory polymer which recovers an original state when the electric current is cut off from the power supply.

6. The hard disk drive according to claim 1, wherein the ramp is rotatable by the ramp rotating unit through an angle of approximately 5 degrees to 15 degrees.

7. The hard disk drive according to claim 1, wherein the parking guide rail comprises a front end having a first section which is perpendicular to a length of the parking guide rail and a second section which is inclined with respect to the length of the parking guide rail.

8. The hard disk drive according to claim 2, wherein the emergency parking guide section comprises a wave surface more waved than a surface of the normal parking guide.

9. The hard disk drive according to claim 2, wherein the emergency parking guide section is higher than the normal parking guide section.

10. The hard disk drive according to claim 2, wherein a surface roughness of the emergency parking guide section is different from a surface roughness of the normal parking guide section.

11. A method of operating a hard disk drive including a rotatable actuator arm having an end tap extending therefrom and a rotatable ramp, the method comprising:
during a driving state, positioning the actuator arm in a position over a disk; and
during a normal parking state:
rotating the actuator arm toward the ramp, and
rotating the ramp into a normal parking state position; and
during an emergency parking state,
rotating the actuator arm toward the ramp, and
rotating the ramp into an emergency parking position, different from the normal parking state position.

12. The method according to claim 11, wherein:
rotating the actuator arm toward the ramp and rotating the ramp into the normal parking position comprises bringing the end tap into contact with a normal parking guide section of the ramp; and
rotating the actuator arm toward the ramp and rotating the ramp into the emergency parking position comprises bringing the end tap into contact with an emergency parking guide section of the ramp.

13. The method according to claim 12, wherein:
the normal parking guide section is shorter than the emergency parking guide section.

14. The method according to claim 12, wherein:
the normal parking guide section is more planar than the emergency parking guide section.

15. The method according to claim 12, wherein:
the emergency parking guide section is rougher than the normal parking guide section.
